(19) United States
(12) Patent Application Publication
(10) Pub. No.: US 2009/0169336 A1
(43) Pub. Date: Jul. 2, 2009

(54) Locking Device With Quick Release Mechanism

(76) Inventor: Ting-Kuang Chen, Keelung (TW)

Correspondence Address: RABIN & Berdo, PC, 1101 14TH STREET, NW, SUITE 500, WASHINGTON, DC, 20005, US

(21) Appl. No.: 11/964,918

(22) Filed: Dec. 27, 2007

(51) Int. Cl. F16B 37/08

(52) U.S. Cl. 411/432

(57) ABSTRACT

A locking device includes an outer ring in which a clutch disc and a locking disc are respectively connected at two opposite sides thereof A first pad is located on clutch disc and a second pad is located on the first pad. A plurality of balls are located between adjacent first and second protrusions of the first and second pads. A plurality of springs are biased between the far first and second protrusions. A screw bolt connected with a grinding wheel is threadedly extended through the locking disc. When the outer ring is rotated in first direction, the balls do not fall into the recesses defined in the locking disc so as to push the clutch disc to lock the grinding wheel. When the outer ring is rotated in second direction, the balls fall into the recesses and the clutch disc is loosened from the grinding wheel.

### BACKGROUND OF THE INVENTION

1. Field of the Invention

The present invention relates generally to a locking device for outputting high torque and can be easily operated and released.

2. The Prior Arts

Most of conventional machine, especially for those including rotational parts such as grinding wheels, use bolts or nuts to lock the rotational parts. The bolts or nuts have to be tightened or loosened by tools such as wrenches or screwdrivers. The operation of the wrenches or screwdrivers take a lot of time and effort, and the users have to carry different types of sizes of the tools. This is inconvenient for the users.

### SUMMARY OF THE INVENTION

A primary objective of the present invention is to provide a locking device which is easily operated without using tools and can quickly lock or unlock a rotational part.

The present invention is designed based on a planet gear system which includes an outer ring, balls and a locking disc. The outer ring performs as the ring gears on the outside of the planet gear system, the balls perform as the planet gears and the locking disc performs as the sun gear. When the outer ring is rotated in the first direction, the balls are moved with the outer ring and bring the locking disc to rotate in the same direction so as to lock the rotational part. When the outer ring is rotated in the second direction, the locking disc can be quickly released.

According to the present invention, a locking device is provided and comprises an outer ring having an interior enclosed by a wall thereof, and a clutch disc received in the interior at a first side of the outer ring. A first pad is located on the clutch disc and includes a plurality of first protrusions. A second pad is located on the first pad and including a plurality of second protrusions. A plurality of balls are received in the interior and located between the adjacent first and second protrusions. A plurality of springs are biased between the far first and second protrusions. A locking disc is received in the interior at a second side of the outer ring. A tubular portion extends from a center of the locking disc and through the second pad, the first pad and the clutch disc. The tubular portion is securely connected to the second pad. The balls are located in a space between the clutch disc, the locking disc, an inner periphery of the outer ring, the first pad and the second pad. The locking disc includes a plurality of recesses into which the balls fall.

The locking disc of the present invention includes a screw hole to be connected with a screw bolt of a machine.

There are two O-rings located between the inner periphery of the outer ring and the locking disc and between the inner periphery of the outer ring and the clutch disc to properly position the two discs in the outer ring.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view showing a locking device in accordance with the present invention;

FIG. 2 is a cross-sectional view of the locking device in accordance with the present invention;

FIG. 3 is a cross-sectional view showing balls are fallen into recesses of a locking disc;

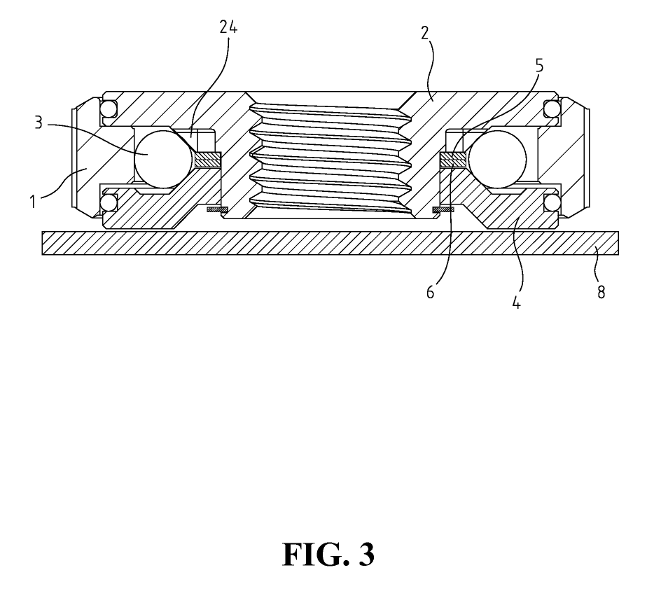

FIG. 4 shows that an outer ring of the locking device is rotated in the first direction to lock a grinding wheel;

FIG. 5 shows the outer ring of the locking device is rotated in the second direction to unlock the grinding wheel; and

FIG. 6 shows that springs push the outer ring back to original position after the outer ring is released.

### DETAILED DESCRIPTION OF THE PREFERRED EMBODIMENT

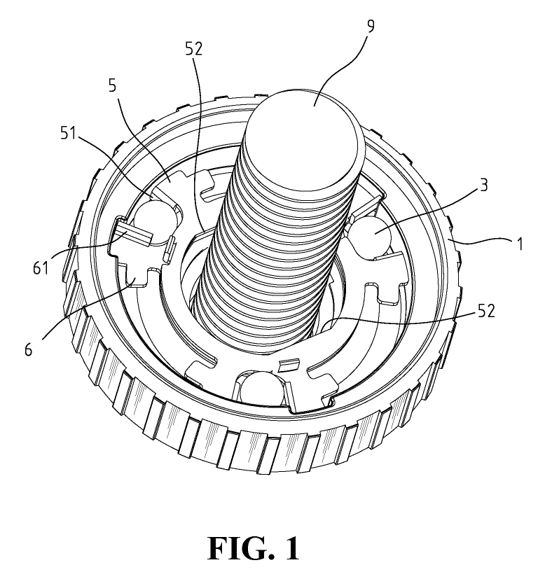

With reference to the drawings and in particular to FIGS. 1, 2 and 4, a locking device comprises an outer ring 1, a clutch disc 4, a locking disc 2, a plurality of balls 3, a first pad 6, a second pad 5 and a plurality of springs 7. The outer ring 1 includes an interior enclosed by a wall thereof, and a plurality of ribs are formed on an outside of the wall for convenience of operation by users' fingers. An inside of the wall includes two receiving space respectively for the clutch disc 4 and the locking disc 2.

The clutch disc 4 is a circular disc and received in the interior. The clutch disc 4 is located at a first side of the outer ring 1 and includes a central hole. An underside of the clutch disc 4 is removably connected to a grinding wheel 8. A first O-ring 41 is located between the inner periphery of the outer ring 1 and the clutch disc 4 so as to provide a damping action to the outer ring 1 and the clutch disc 4 and further position the clutch disc 4 relative to the inner periphery of the outer ring 1.

The first pad 6 is received in the interior and located on the clutch disc 4, the first pad 6 includes a plurality of first protrusions 61 extending upward from a periphery thereof at equal interval. A central hole is defined through a center of the first pad 6.

The second pad 5 is received in the interior and located on the first pad 6, and the second pad 5 includes a plurality of second protrusions 51 extending downward from a periphery thereof at equal interval. A central hole is defined through a center of the second pad 5, and two first flat surfaces 52 are defined in an inner periphery of the central hole.

The balls 3 are received in the interior and located between the adjacent first and second protrusions 61, 51 respectively.

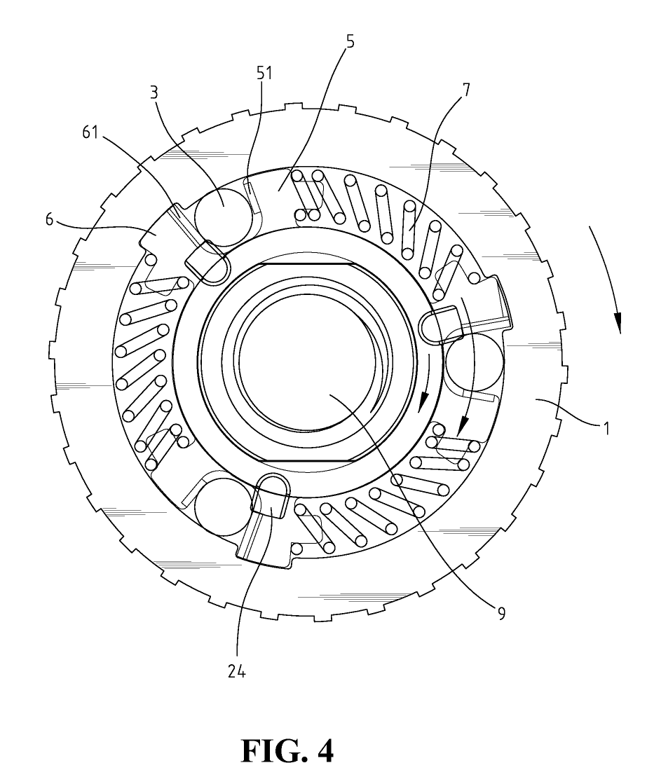

The springs 7 are received in the interior and located between the far first and second protrusions 61, 51. The two ends of each spring 7 are biased against the first and second protrusions 61, 52 respectively as shown in FIG. 4.

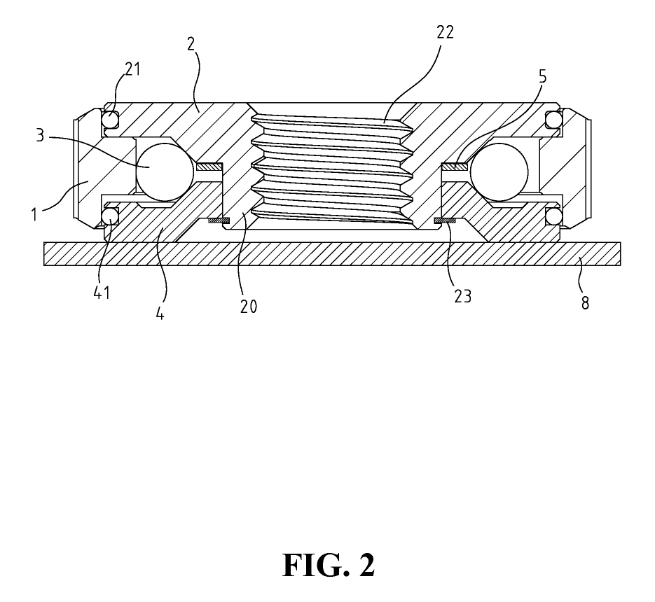

The locking disc 2 is received in the interior and located at a second side of the outer ring 1. A tubular portion 20 extends from a center of the locking disc 2 and through the central hole of the second pad 5, the central hole of the first pad 6 and the central hole of the clutch disc 4. A clipping ring 23 as shown in FIG. 2 is then clipped on the tubular portion 20. The tubular portion 20 includes two second flat surfaces (not shown) which are matched with the first flat surfaces 52 so that the second pad 5 is securely connected with the tubular portion 20, and the second pad 5 does not rotate relative to the tubular portion 20. The balls 3 are located in a space between the clutch disc 4, the locking disc 2, an inner periphery of the outer ring 1, the first pad 6 and the second pad 5. The locking disc 2 includes a plurality of recesses 24 into which the balls 3 fall. The tubular portion 20 of the locking disc 2 includes a screw hole 22 defined therethrough so as to be connected with a screw bolt 9 of a machine. A second O-ring 21 is located between the inner periphery of the outer ring 1 and the locking disc 2 so as to provide a damping action to the outer ring 1 and the locking disc 2 and further position the locking disc 2 relative to the inner periphery of the outer ring 1.

The arrangement of the parts mentioned above forms as a planet gear system wherein the outer ring 1 performs as the ring gears on the outside of the planet gear system, the balls 3 perform as the planet gears and the locking disc 2 performs as the sun gear.

As shown in FIG. 4, when the outer ring 1 is rotated in the first direction (clockwise), the balls 3 are moved with the outer ring 1 due to friction and push the second protrusions 51 to rotate the second pad 5. Because the second pad 5 is securely connected to the locking disc 2, the locking disc 2 is rotated with the second pad 5 as well. The balls 3 do not fall into the recesses 24 in the locking disc 2 so that the clutch disc 4 is supported by the balls 3 and pushed toward the grinding wheel 8 which is locked in the first direction.

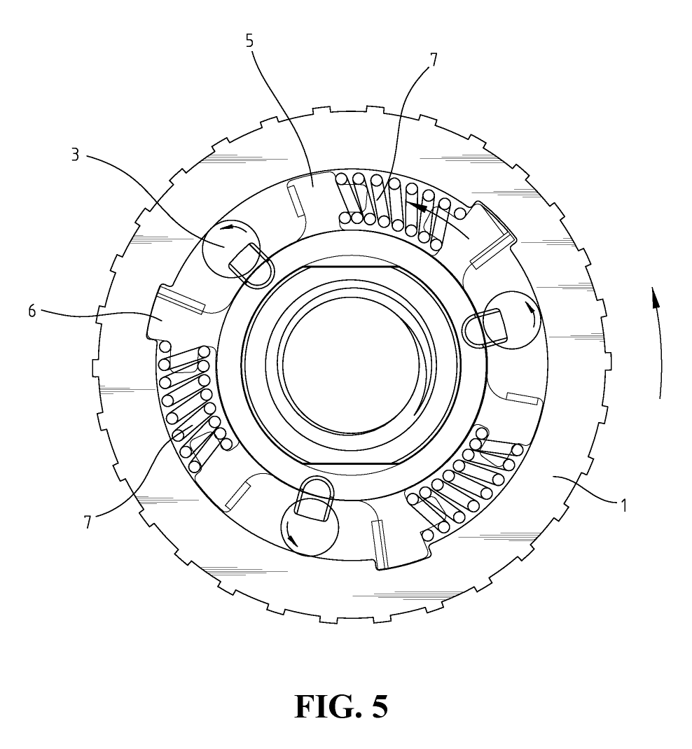

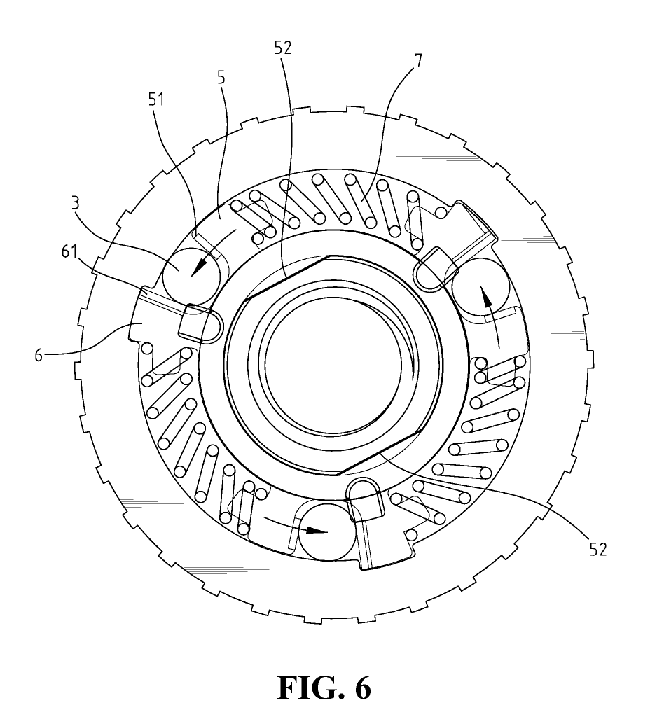

As shown in FIG. 5, when the outer ring 1 is rotated in the second direction (counter clockwise), the balls 3 are moved with the outer ring 1 due to friction and push the first protrusions 61 to rotate the first pad 6 in the second direction such that the springs 7 are compressed. When the balls 3 move to the recesses 24, the balls 3 fall into the recesses 24 in the locking disc 2 so that the clutch disc 4 is not supported by the balls 3 and a gap is defined between the clutch disc 4 and the grinding wheel 8 such that the grinding wheel 8 can be then loosened easily. As shown in FIG. 6, at this moment, the springs 7 release their spring force to move the second pad 5 back to its original position in the second direction, the locking disc 2 is then co-rotated with the second pad 5 to be loosened. This makes the user to easily and quickly lock and unlock the grinding wheel 8.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A locking device comprising
an outer ring having an interior enclosed by a wall thereof;
a clutch disc received in the interior and located at a first side of the outer ring;
a first pad received in the interior and located on the clutch disc, the first pad including a plurality of first protrusions;
a second pad received in the interior and located on the first pad, the second pad including a plurality of second protrusions;
a plurality of balls received in the interior and located between the adjacent first and second protrusions;
a plurality of springs received in the interior and each being biased between the far first and second protrusions, and
a locking disc received in the interior and located at a second side of the outer ring, a tubular portion extending from a center of the locking disc and through the second pad, the first pad and the clutch disc, the tubular portion securely connected to the second pad, the balls located in a space between the clutch disc, the locking disc, an inner periphery of the outer ring, the first pad and the second pad, the locking disc including a plurality of recesses into which the balls fall.

2. The locking device as claimed in claim 1, wherein the second pad includes a central hole, and two first flat surfaces are defined in an inner periphery of the central hole, the tubular portion of the locking disc includes two second flat surfaces which are matched with the first flat surfaces.

3. The locking device as claimed in claim 1, wherein the tubular portion of the locking disc includes a screw hole defined therethrough so as to be connected with a screw bolt.

4. The locking device as claimed in claim 1, wherein a first O-ring is located between the inner periphery of the outer ring and the clutch disc.

5. The locking device as claimed in claim 1, wherein a second O-ring is located between the inner periphery of the outer ring and the locking disc.
